(19) United States
(12) Patent Application Publication
(10) Pub. No.: US 2025/0301383 A1
(43) Pub. Date: Sep. 25, 2025

(54) INFORMATION PROCESSING METHOD AND APPARATUS, TERMINAL, AND NETWORK-SIDE DEVICE

(71) Applicant: VIVO MOBILE COMMUNICATION CO., LTD., Dongguan (CN)

(72) Inventors: Yangyang WANG, Dongguan (CN); Wei BAO, Dongguan (CN)

(21) Appl. No.: 19/231,595

(22) Filed: Jun. 9, 2025

Related U.S. Application Data
(63) Continuation of application No. PCT/CN2023/136016, filed on Dec. 4, 2023.

(30) Foreign Application Priority Data
Dec. 9, 2022 (CN) 202211593822.6

(51) Int. Cl. H04W 36/08; H04L 1/1812; H04W 36/04

(52) U.S. Cl. CPC H04W 36/08; H04L 1/1812; H04W 36/04

(57) ABSTRACT

Provided are information processing methods, a terminal, and a network-side device. The method includes: a terminal receives a serving cell change command, where the serving cell change command indicates the terminal to perform a serving cell change; the terminal performs the serving cell change; the terminal receives, after performing the serving cell change, retransmitted data of a source serving cell from a target serving cell based on HARQ information indicated in a downlink assignment that is received by the target serving cell; and in a case that the terminal stores unsuccessfully decoded data of the source serving cell in an HARQ buffer in a first HARQ process of a first HARQ entity, the terminal combines the unsuccessfully decoded data of the source serving cell and the retransmitted data of the source serving cell received from the target serving cell, and decodes the combined data.

### CROSS-REFERENCE TO RELATED APPLICATIONS

This application is a continuation of International Patent Application No. PCT/CN2023/136016, filed on Dec. 4, 2023, which claims priority to Chinese Patent Application No. 202211593822.6, filed with the China National Intellectual Property Administration on Dec. 9, 2022 and entitled “INFORMATION PROCESSING METHOD AND APPARATUS, TERMINAL, AND NETWORK-SIDE DEVICE”, which is incorporated herein by reference in its entirety.

### TECHNICAL FIELD

This application relates to the field of communication technologies, and specifically, to an information processing method and apparatus, a terminal, and a network-side device.

### BACKGROUND

In a current protocol, when performing a serving cell change, the terminal performs medium access control reset (Medium Access Control reset, MAC reset). In this case, a hybrid automatic repeat request (Hybrid Automatic Repeat request, HARQ) entity of each source serving cell before the serving cell change is deleted, and a new HARQ entity is created for each target serving cell obtained after the serving cell change.

### SUMMARY

Embodiments of this application provide an information processing method and apparatus, a terminal, and a network-side device.

According to a first aspect, an information processing method is provided, including:
receiving, by a terminal, a serving cell change command, where the serving cell change command indicates the terminal to perform a serving cell change;
performing, by the terminal, the serving cell change;
receiving, by the terminal after performing the serving cell change, retransmitted data of a source serving cell from a target serving cell based on HARQ information indicated in a downlink assignment that is received by the target serving cell; and
in a case that the terminal stores unsuccessfully decoded data of the source serving cell in an HARQ buffer in a first HARQ process of a first HARQ entity, combining the unsuccessfully decoded data of the source serving cell and the retransmitted data of the source serving cell received from the target serving cell, and decoding the combined data, where the unsuccessfully decoded data is new transmitted data or the retransmitted data of the source serving cell, where
the target serving cell is a serving cell obtained after the terminal performs the serving cell change, and the source serving cell is a serving cell obtained before the terminal performs the serving cell change.

According to a second aspect, an information processing method is provided, including:
sending, by a network-side device, a serving cell change command, where the serving cell change command indicates a terminal to perform a serving cell change;
after performing the serving cell change, performing, by the network-side device, at least one of the following:
triggering initial transmission or retransmission in a first HARQ process of a first HARQ entity associated with a source serving cell of the terminal;
in a case that data that is successfully decoded in a hybrid automatic repeat request buffer HARQ buffer in a third HARQ process of a second HARQ entity is initially transmitted by the terminal to the source serving cell and retransmitted to a target serving cell, and the data is associated with control signaling, deleting the data of the control signaling; and
in a case that data that is successfully decoded in an HARQ buffer in a third HARQ process of a second HARQ entity is initially transmitted by the terminal to the source serving cell and retransmitted to a target serving cell, and the data is associated with a data radio bearer, transmitting the data associated with the data radio bearer to a higher layer, where
the source serving cell is a serving cell obtained before the terminal performs the serving cell change, and the target serving cell is a serving cell obtained after the terminal performs the serving cell change.

According to a third aspect, an information processing apparatus is provided and executed by a terminal, where the apparatus includes:
a first receiving module, configured to receive a serving cell change command, where the serving cell change command indicates the terminal to perform a serving cell change;
a first processing module, configured to perform the serving cell change;
a second receiving module, configured to receive, after performing the serving cell change, retransmitted data of a source serving cell from a target serving cell based on HARQ information indicated in a downlink assignment that is received by the target serving cell; and
a second processing module, configured to: in a case that the terminal stores unsuccessfully decoded data of the source serving cell in an HARQ buffer in a first HARQ process of a first HARQ entity, combine the unsuccessfully decoded data of the source serving cell and the retransmitted data of the source serving cell received from the target serving cell, and decode the combined data, where the unsuccessfully decoded data is new transmitted data or the retransmitted data of the source serving cell, where
the target serving cell is a serving cell obtained after the terminal performs the serving cell change, and the source serving cell is a serving cell obtained before the terminal performs the serving cell change.

According to a fourth aspect, an information processing apparatus is provided and executed by a network-side device, where the apparatus includes:
a sending module, configured to send a serving cell change command, where the serving cell change command indicates a terminal to perform a serving cell change;
a processing module, configured to: after performing the serving cell change, perform at least one of the following:
trigger initial transmission or retransmission in a first HARQ process of a first HARQ entity associated with a source serving cell of the terminal;
in a case that data that is successfully decoded in a hybrid automatic repeat request buffer HARQ buffer in a third HARQ process of a second HARQ entity is initially transmitted by the terminal to the source serving cell and retransmitted to a target serving cell, and the data is associated with control signaling, delete the data of the control signaling; and
in a case that data that is successfully decoded in an HARQ buffer in a third HARQ process of a second HARQ entity is initially transmitted by the terminal to the source serving cell and retransmitted to a target serving cell, and the data is associated with a data radio bearer, transmit the data associated with the data radio bearer to a higher layer, where
the source serving cell is a serving cell obtained before the terminal performs the serving cell change, and the target serving cell is a serving cell obtained after the terminal performs the serving cell change.

According to a fifth aspect, a terminal is provided, including a processor and a memory. The memory stores a program or instructions that can be run on the processor, and when the program or the instructions are executed by the processor, steps of the information processing method according to the first aspect are implemented.

According to a sixth aspect, a network-side device is provided, including a processor and a memory. The memory stores a program or instructions that can be run on the processor, and when the program or the instructions are executed by the processor, steps of the information processing method according to the second aspect are implemented.

According to a seventh aspect, an information processing system is provided, including: a network-side device and a terminal, where the terminal is configured to perform steps of the information processing method according to the first aspect, and the network-side device is configured to perform steps of the information processing method according to the second aspect.

According to an eighth aspect, a readable storage medium is provided. The readable storage medium stores a program or instructions, and when the program or the instructions are executed by a processor, steps of the information processing method according to the first aspect or the second aspect are implemented.

According to a ninth aspect, a chip is provided. The chip includes a processor and a communication interface. The communication interface is coupled to the processor, and the processor is configured to run a program or instructions to implement the information processing method according to the first aspect or the second aspect.

According to a tenth aspect, a computer program/program product is provided. The computer program/program product is stored in a storage medium. The computer program/program product is executed by at least one processor to implement the steps of the information processing method according to the first aspect or the second aspect.

### BRIEF DESCRIPTION OF THE DRAWINGS

To describe embodiments of this application more clearly, the following briefly introduces the accompanying drawings required for describing embodiments. It is clear that the accompanying drawings in the following descriptions show only some embodiments of this application, and a person of ordinary skill in the art may still derive other drawings from these accompanying drawings without creative efforts.

FIG. 1 is a block diagram of a wireless communication system to which an embodiment of this application is applicable;

FIG. 2 is a flowchart of an information processing method according to an embodiment of this application;

FIG. 3 is a flowchart of another information processing method according to an embodiment of this application;

FIG. 4 is a block diagram of a structure of an information processing apparatus according to an embodiment of this application;

FIG. 5 is a block diagram of a structure of another information processing apparatus according to an embodiment of this application;

FIG. 6 is a block diagram of a structure of a communication device according to an embodiment of this application;

FIG. 7 is a diagram of a hardware structure of a terminal according to an embodiment of this application;

FIG. 8 is a block diagram of a structure of a terminal according to an embodiment of this application; and

FIG. 9 is a block diagram of a structure of a network-side device according to an embodiment of this application.

### DETAILED DESCRIPTION

The following clearly describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application fall within the protection scope of this application.

The terms “first”, “second”, and the like in this application are intended to distinguish similar objects, but are not necessarily used to describe a specific order or sequence. It should be understood that terms used in such a way are interchangeable in proper circumstances, so that embodiments of this application described herein can be implemented in an order different from the order illustrated or described herein. In addition, the objects distinguished by “first” and “second” are usually one category, and a quantity of objects is not limited. For example, the first object may be one or at least two. In addition, “and/or” used in this specification and the claims represents at least one of connected objects. The character “/” usually indicates an “or” relationship between associated objects.

The term “indication” in this application may be a direct indication (or an explicit indication), or may be an indirect indication (or an implicit indication). The direct indication may be understood as that a transmitter explicitly notifies a receiver of content of a sent indication such as specific information, an operation that needs to be performed, or a request result. The indirect indication may be understood as that a receiver determines corresponding information according to an indication sent by a transmitter, or performs determining and determines an operation that needs to be performed or a request result according to a determining result.

It should be noted that the technology described in embodiments of this application is not limited to being used in a long-term evolution (Long-Term Evolution, LTE)/LTE-advanced (LTE-Advanced, LTE-A) system, and may be further applied to another wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single carrier-frequency division multiple access (Single carrier-Frequency Division Multiple Access, SC-FDMA), or another system. The terms “system” and “network” are often interchangeably used in embodiments of this application, and the technology described may be used for both the system and radio technology mentioned above, and used for another system and radio technology. The following descriptions describe a new radio (New Radio, NR) system for purposes of example, and the term of NR is used in most of the following descriptions, but these technologies are also applicable to an application beyond an NR system application, for example, a 6th generation (6th Generation, 6G) communication system.

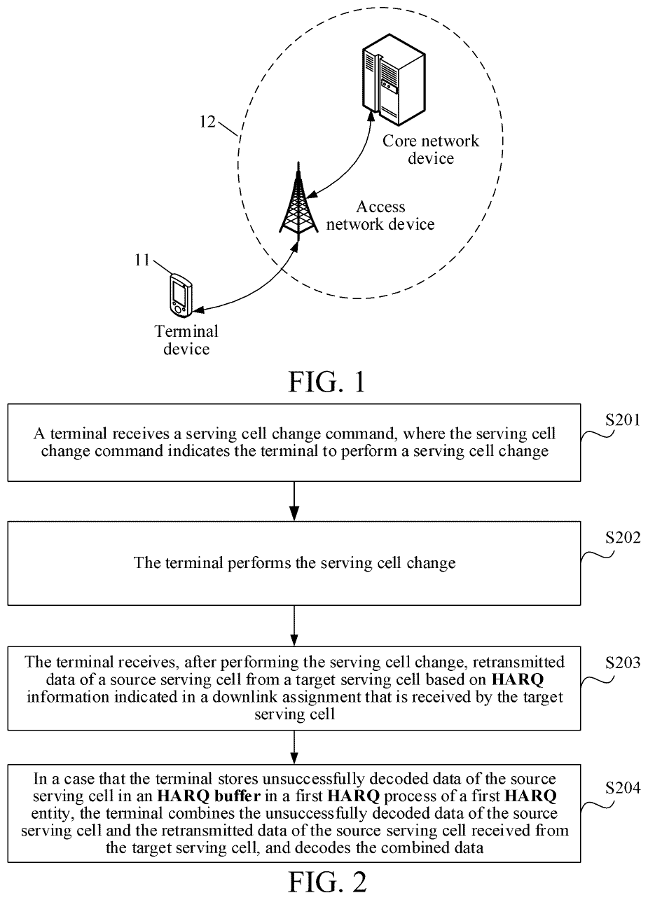

FIG. 1 is a block diagram of a wireless communication system to which an embodiment of this application is applicable. The wireless communication system includes a terminal device 11 and a network-side device 12. The terminal device 11 may be a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR)/virtual reality (Virtual Reality, VR) device, a robot, a wearable device (Wearable Device), a flight vehicle (flight vehicle), vehicular user equipment (Vehicle User Equipment, VUE), a ship device, pedestrian user equipment (Pedestrian User Equipment, PUE), a smart home (a home device having a wireless communication function, such as a refrigerator, a television, a washing machine, furniture, or the like), a game console, a personal computer (personal computer, PC), a teller machine or a self-service machine, or another terminal-side device. The wearable device includes: a smart watch, a smart band, smart headphones, smart glasses, smart jewelry (a smart bangle, a smart bracelet, a smart ring, a smart necklace, a smart ankle bracelet, a smart anklet, and the like), a smart wristband, smart clothing, and the like. The in-vehicle device may alternatively be referred to as an in-vehicle terminal, an in-vehicle controller, an in-vehicle module, an in-vehicle component, an in-vehicle chip, an in-vehicle unit, or the like. It should be noted that, a specific type of the terminal device 11 is not limited in embodiments of this application. The network-side device 12 may include an access network device or a core network device. The access network device 12 may alternatively be referred to as a radio access network device, a radio access network (Radio Access Network, RAN), a radio access network function, or a radio access network element. The access network device 12 may include a base station, a wireless local area network (Wireless Local Area Network, WLAN), a WLAN access point (Access Point, AP), a wireless fidelity (Wireless Fidelity, Wi-Fi) node, or the like. The base station may be referred to as a NodeB (NodeB, NB), an evolved NodeB (Evolved NodeB, eNB), a next generation NodeB (the next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another appropriate term in the art. As long as the same technical effects are achieved, the base station is not limited to a specific technology vocabulary. It should be noted that, only a base station in an NR system is used as an example in embodiments of this application, and a specific type of the base station is not limited. A core network device may include, but is not limited to, at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF), an edge application server discovery function (Edge Application Server Discovery Function, EASDF), unified data management (Unified Data Management, UDM), unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF, or an L-NEF), a binding support function (Binding Support Function, BSF), an application function (Application Function, AF), or the like. It needs to be noted that, only a core network device in an NR system is used as an example in embodiments of this application, and a specific type of the core network device is not limited.

In a current protocol, when a terminal performs a serving cell change, the terminal performs media access control reset, that is, flushes data at a media access control (Medium Access Control, MAC) layer. For example, soft buffers (soft buffers) of all downlink HARQ processes are flushed, and for each downlink HARQ process, next received transport block (Transport Block, TB) transmission is considered as initial transmission. Consequently, data stored in an HARQ entity of each source serving cell is discarded, and a quantity of times of data retransmission of a target serving cell is increased.

For the problems existing in the conventional technology, this application provides an information processing method, so that the terminal can maintain data continuity as much as possible in a serving cell change scenario, to resolve a problem that useful data in the HARQ buffer is discarded during the serving cell change, and reduce a quantity of times of data retransmission of the target serving cell. The following describes in detail the information processing method according to embodiments of this application through some embodiments and application scenarios thereof with reference to the accompanying drawings.

According to a first aspect, FIG. 2 is a flowchart of an information processing method according to an embodiment of this application. The method may include the following steps.

Step S201: A terminal receives a serving cell change command, where the serving cell change command indicates the terminal to perform a serving cell change.

The serving cell change command includes at least one of the following: a handover command, a PSCell switch command, a secondary cell handover command, L1/L2-triggered mobility signaling (L1/L2-triggered mobility).

Step S202: the terminal performs the serving cell change.

It should be noted that, that the terminal performs the serving cell change includes at least that a special cell configured for the terminal is changed, includes or does not include that a secondary cell of the terminal is changed, and also includes a scenario in which a secondary cell configured for the terminal may not be changed. That is, a source serving cell and a target serving cell described below may have the same or different secondary cells. The source serving cell and the target serving cell are mainly used for distinguishing, in terms of time, serving cells configured before and after the terminal performs the serving cell change. For example, for a serving cell A configured for the terminal, the serving cell A is not changed during the serving cell change performed by the terminal. In this case, before the serving cell is changed, the serving cell A configured for the terminal is the source serving cell, and after the serving cell is changed, the serving cell A configured for the terminal is the target serving cell.

Step S203: The terminal receives, after performing the serving cell change, retransmitted data of a source serving cell from a target serving cell based on HARQ information indicated in a downlink assignment that is received by the target serving cell.

The retransmitted data of the source serving cell that is received by the terminal from the target serving cell is: the data that is initially transmitted by the source serving cell to the terminal, and retransmitted by the target serving cell to the terminal due to reasons such as a failure to send an acknowledgment to a network of the source serving cell or unsuccessfully decoding by the source serving cell. It may be understood that, the retransmitted data includes data that is initially transmitted by the source serving cell and retransmitted to the terminal for a plurality of times after the initial transmission, and is unsuccessfully transmitted by the source serving cell and needs to be retransmitted by the target serving cell to the terminal again, and the data is data that is unsuccessfully transmitted by the source serving cell for one or more times and retransmitted by the target serving cell to the terminal for a plurality of times.

During specific implementation, after performing the serving cell change, the terminal may determine, based on the HARQ information, whether the data transmitted by the target serving cell is the retransmitted data of the source serving cell during initial transmission or the data that is initially transmitted by the target serving cell during initial transmission, to combine and decode the retransmitted data of the source serving cell during initial transmission or send acknowledgment information. It may be understood that, this application mainly aims to determine whether the data transmitted by the target serving cell is the retransmitted data of the source serving cell during initial transmission after the terminal performs the serving cell change. In a case that the target serving cell initially transmits the data in an HARQ process and associated HARQ information indicates that the data is the retransmitted data, the terminal may determine that the retransmitted data initially transmitted in the HARQ process is the retransmitted data of the source serving cell during initial transmission. For the new transmitted data and the retransmitted data of the target serving cell during initial transmission, the terminal may perform conventional processing based on a protocol agreement. This is not limited in this application.

Step S204: In a case that the terminal stores unsuccessfully decoded data of the source serving cell in an HARQ buffer in a first HARQ process of a first HARQ entity, the terminal combines the unsuccessfully decoded data of the source serving cell and the retransmitted data of the source serving cell received from the target serving cell, and decodes the combined data.

The unsuccessfully decoded data is the new transmitted data or retransmitted data of the source serving cell. The first HARQ entity is an HARQ entity for which data stored in the HARQ buffer in the first HARQ process of the source serving cell is not flushed during the serving cell change performed by the terminal.

During specific implementation, after performing the serving cell change, the terminal may combine the retransmitted data of the source serving cell received from the target serving cell and the unsuccessfully decoded data of the source serving cell reserved in the HARQ buffer, and decode the combined data, so that the decoding accuracy may be improved, to reduce a quantity of times of retransmission of the data by the target serving cell.

It can be learned from the foregoing steps that, during the serving cell change, the terminal at least reserves the unsuccessfully decoded data of the source serving cell in the first HARQ entity; and after performing the serving cell change, the terminal combines the unsuccessfully decoded data of the source serving cell and the corresponding retransmitted data received from the target serving cell, and decodes the combined data, to resolve a problem that useful data is discarded during the serving cell change, and reduce a quantity of times of data retransmission of the target serving cell.

### Implementation 1

According to this implementation, processing of information associated with downlink data during a serving cell change by a terminal is described. Processing of the information associated with the downlink data may be specifically divided into the following three cases according to two key time points for the terminal to perform a serving cell change (an interval between the terminal receives a serving cell change command and performs the serving cell change, and a time point after performing the serving cell change).

Case 1: During the interval between receiving the serving cell change command and performing the serving cell change, the terminal continues to complete the decoding of the data that is being decoded in each second HARQ process in the first HARQ entity. After the decoding is completed, the terminal performs a first operation on the first HARQ entity. The first operation includes at least one of the following:

A-1: In a case that data that is successfully decoded in an HARQ buffer in a second HARQ process of the first HARQ entity is associated with control signaling, delete the data associated with the control signaling.

During specific implementation, for the successfully decoded data, the terminal may determine whether each MAC subprotocol data unit (subProtocol Data Unit, subPDU) in the successfully decoded data (that is, a protocol data unit (Protocol Data Unit, MAC PDU)) is associated with a signaling radio bearer (Signaling Radio Bearer, SRB), and determine each MAC subPDU associated with the SRB (which may be any one of an SRB 1, an SRB 2, an SRB 3, and an SRB 4) as the data associated with the control signaling, and delete the data.

A-2: A MAC layer entity of the terminal sends first target indication information to radio resource control (Radio Resource Control, RRC), and the RRC indicates, based on the first target indication information, a packet data convergence protocol (Packet Data Convergence Protocol, PDCP) entity and a radio link control (Radio Link Control, RLC) entity that are associated with the SRB to flush the stored data, where the first target indication information indicates that UE performs the serving cell change.

It may be understood that, useless data reserved during the serving cell change performed by the terminal may be reduced by flushing the data stored in the PDCP entity and the RLC entity that are associated with the SRB or deleting the data associated with the control signaling. The first target indication information may further indicate at least one of the following: a DU serving cell change, MAC layer reservation, HARQ reservation, and L2 reservation.

A-3: In a case that data that is successfully decoded in an HARQ buffer in a second HARQ process is associated with a data radio bearer of the source serving cell, transmit the data associated with the data radio bearer of the source serving cell to a higher layer.

During specific implementation, for the successfully decoded data, the terminal may determine whether each MAC subPDU in the successfully decoded data is associated with the data radio bearer (Data Radio Bearer, DRB), and transmit each MAC subPDU associated with the DRB to a higher layer (for example, an RRC layer) for processing.

A-4: Reserve data and HARQ information in an HARQ buffer in a second HARQ process.

During specific implementation, the terminal may reserve the unsuccessfully decoded data with the NACK indication information in the HARQ buffer in the first HARQ process, so that after the terminal performs the serving cell change, a network-side device triggers data retransmission in the first HARQ process of the first HARQ entity, to maintain continuity of information before and after the terminal performs the serving cell change, and reduce cases in which useful data is discarded.

In addition, the terminal may further reserve the successfully decoded MAC PDU in a soft buffer in the second HARQ process, and reserve the HARQ information. After the terminal performs the serving cell change, the reserved data is data of the source serving cell that has been successfully decoded by the terminal but has not yet been able to send the ACK indication information, so that when the terminal receives, in the target serving cell, the HARQ indication information for retransmitting the data of the second HARQ process, the terminal may skip receiving and/or decoding the data and/or sending the data to a higher layer for continued processing, and send acknowledgment information to a network of the target serving cell. The terminal may further store the unsuccessfully decoded data in the soft buffer in the HARQ process, and reserve the HARQ information. The HARQ information is subsequently used as the unsuccessfully decoded data of the source serving cell of the terminal that has not yet been able to send NACK indication information, to further maintain continuity of the information before and after the terminal performs the serving cell change.

Case 2: After the terminal performs the serving cell change, the terminal continues to receive the data from the target serving cell and send the data to the target serving cell, and combines and decodes the received retransmitted data from the source serving cell or sends an acknowledgment notification.

During specific implementation, after the terminal performs the serving cell change, the terminal may monitor, at a physical downlink control channel occasion (Physical Downlink Control Channel occasion, PDCCH occasion), a downlink assignment (downlink assignment) scrambled by a cell-radio network temporary identifier (Cell-Radio Network Temporary Identifier, C-RNTI) corresponding to the terminal. After monitoring the downlink assignment associated with the first HARQ entity, the terminal receives, from a physical layer, a TB associated with the downlink assignment, and then transmits, via the first HARQ entity based on HARQ information of the TB, the TB and the HARQ information to a related first HARQ process for combination and decoding. The terminal may determine whether the data received from the TB is retransmitted data or new transmitted data based on a new data indicator (New Data Indicator, NDI) in the HARQ information carried in the downlink assignment.

In a case that the combined data is successfully decoded, the terminal performs at least one of the following operations on the decoded combined data: deleting the decoded combined data in a case that the decoded combined data is associated with control signaling. If the decoded combined data is associated with a data radio bearer DRB, the decoded combined data is reserved, to delete useless data (that is, the control signaling of the source serving cell) and reserve useful data (that is, service data (the data associated with the DRB) of the source serving cell). The terminal may determine, based on a logical channel identifier (Logical Channel ID, LCID) of header information of each MAC subPDU in the decoded combined data, whether the MAC subPDU is associated with the SRB or the DRB.

In a case that the combined data is unsuccessfully decoded, the terminal stores the retransmitted data of the source serving cell received from the target serving cell in the HARQ buffer in the first HARQ process, to subsequently combine and decode the unsuccessfully decoded combined data and newly received retransmitted data again, and/or a MAC layer entity of the terminal indicates a physical layer to send NACK indication information for the data in the TB associated with the first HARQ process, to request the network-side device to retransmit the data.

After the terminal completes the combination and decoding, the terminal may further determine HARQ feedback information (for example, the ACK indication information) of the retransmitted data based on successful or unsuccessful combination and decoding. Specifically, the terminal may perform either one of the following operations:
in a case that the terminal stores successfully decoded data of the source serving cell in the HARQ buffer in the first HARQ process, and the terminal receives, from the target serving cell, the downlink assignment indicating retransmission of the first HARQ process, indicating, by a medium access control MAC layer entity of the terminal, a physical layer to send ACK indication information for data in a transport block TB associated with the first HARQ process. In this case, the terminal may skip receiving and/or decoding the retransmitted data associated with the downlink assignment and/or sending the retransmitted data to a higher layer for processing, to avoid repeatedly receiving and/or decoding the retransmitted data that has been successfully decoded and/or sending the retransmitted data to the higher layer for processing; and
in a case that the terminal successfully decodes the data that is obtained after the terminal combines the data in the HARQ buffer in the first HARQ process and the retransmitted data of the source serving cell received from the target serving cell, a MAC layer entity of the terminal indicates a physical layer to send ACK indication information for data in a TB associated with the first HARQ process. It may be understood that, the terminal may combine and decode the unsuccessfully decoded data in the HARQ buffer and the corresponding retransmitted data, and send ACK indication information in a case that the combined data is successfully decoded, to indicate that the network-side device may send the new transmitted data in the first HARQ process.

Case 3: The network-side device sends a serving cell change command to the terminal, and after the serving cell is changed, the network-side device triggers, based on the ACK/NACK indication information sent by the terminal, initial transmission or retransmission in the first HARQ process of the first HARQ entity associated with the source serving cell of the terminal.

The network-side device triggers initial transmission in the first HARQ process in a case that the source serving cell receives ACK indication information from the terminal for data in a TB associated with the first HARQ process of the source serving cell, or the data in the HARQ buffer in the first HARQ process is associated with the control signaling. Specifically, in a case that the network-side device learns that the data associated with the first HARQ process has been successfully decoded or the data is associated with the control signaling of the source serving cell, the network-side device sends a first downlink assignment to the terminal, where an NGI included in the first downlink assignment in the HARQ information in the first HARQ process is toggled, so that the terminal receives new downlink data. For example, in a case that the network-side device determines that data (all MAC subPDUs associated with the TB) previously sent in the first HARQ process is completely associated with the SRB, the network-side device triggers initial transmission in the first HARQ process, and the NDI included in the first downlink assignment in the HARQ information in the first HARQ process is toggled.

The network-side device triggers retransmission in the first HARQ process in a case that the source serving cell does not receive ACK indication information from the terminal for data in a TB associated with the first HARQ process of the source serving cell, or the source serving cell receives NACK indication information from the terminal for data in a TB associated with the first HARQ process of the source serving cell. Specifically, if the network-side device does not receive the corresponding ACK indication information or receives the NACK indication information before the cell change, the network-side device triggers, after the terminal performs the serving cell change, retransmission in the corresponding first HARQ process. That is, the network-side device sends a second downlink assignment to the terminal, where an NDI included in the second downlink assignment in the HARQ information in the first HARQ process is not toggled, so that the terminal receives the corresponding retransmitted data.

### Implementation 2

According to this implementation, processing of information associated with uplink data during a serving cell change by a terminal is described. According to behaviors performed by a network-side device and a terminal, processing of information associated with the uplink data may be specifically divided into the following two cases.

Case 1: After the serving cell change is performed, the network-side device deletes or reserves the successfully decoded data associated with the source serving cell, and triggers, based on the received data, initial transmission or retransmission in a first HARQ process of a first HARQ entity associated with the source serving cell of the terminal.

During deleting or reserving the successfully decoded data associated with the source serving cell, the network-side device performs at least one of the following:
in a case that data that is successfully decoded in an HARQ buffer in a third HARQ process of a second HARQ entity is initially transmitted by the terminal to the source serving cell and retransmitted to a target serving cell, and the data is associated with control signaling, deleting the data of the control signaling; and
in a case that data that is successfully decoded in an HARQ buffer in a third HARQ process of a second HARQ entity is initially transmitted by the terminal to the source serving cell and retransmitted to a target serving cell, and the data is associated with a data radio bearer, transmitting the data associated with the data radio bearer to a higher layer.

During specific implementation, the network-side device determines, for uplink data that is successfully decoded and that is initially transmitted by the source serving cell, whether a MAC subPDU included in the successfully decoded uplink data is associated with an SRB or a DRB. If the MAC subPDU is associated with the DRB, the data is reserved; or if the MAC subPDU is associated with the SRB, the data is ignored. It should be noted that, data processing in this embodiment includes that: after the network-side device sends the serving cell change command, the data received from the source serving cell exists in the third HARQ process of the network side, but the data has not yet been decoded, and after the serving cell is changed, decoding of the data in the third HARQ process is completed and the data is not transmitted to a higher layer.

During the triggering of initial transmission or retransmission in the first HARQ process of the first HARQ entity associated with the source serving cell of the terminal, the network-side device performs the following operations:
before the terminal performs the serving cell change, the network-side device sends, to the terminal, an uplink grant for the first HARQ process or a configuration grant with the first HARQ process, and in a case that the source serving cell correctly receives corresponding data sent by the terminal, the network-side device triggers initial transmission in the first HARQ process after the terminal performs the serving cell change. That is, in a case that the network-side device correctly obtains the data sent by the terminal, the network-side device sends the first uplink grant to the terminal, where an NDI in the HARQ information in the first HARQ process that is included in the first uplink grant is toggled, to indicate the terminal to send new uplink data.

Before the terminal performs the serving cell change, the network-side device sends, to the terminal, an uplink grant for the first HARQ process or a configuration grant with the first HARQ process, and in a case that the source serving cell does not receive corresponding data sent by the terminal, the network-side device triggers retransmission in the first HARQ process after the terminal performs the serving cell change. That is, in a case that the network-side device does not correctly obtain the data sent by the terminal, the network-side device sends a second uplink grant to the terminal, where an NDI in the HARQ information in the first HARQ process that is included in the second uplink grant is not toggled, to indicate the terminal to send the uplink data again. Case 2: The terminal does not flush the data in the first HARQ entity, and the MAC layer of the terminal stops sending uplink data to the physical layer upon receiving the serving cell change command. After the terminal performs the serving cell change, the terminal monitors, at a physical downlink control channel occasion (Physical Downlink Control Channel occasion, PDCCH occasion), an uplink grant (uplink grant) scrambled by a C-RNTI, and determines, via the first HARQ entity, the first HARQ process associated with the detected uplink grant. Specifically, there is data (that is, the data transmitted to the source serving cell) in the HARQ buffer associated with the first HARQ process, and the NDI in the HARQ information indicates that the target serving cell needs to retransmit the data. That is, the NDI in the detected uplink grant is not toggled. In this case, the terminal retransmits the data in the HARQ buffer to a bottom layer (for example, a physical layer) for transmission.

### Implementation 3

This implementation describes a case of how to determine and process an HARQ entity that needs to be reserved during a serving cell change (that is, the first HARQ entity). The HARQ entity that needs to be reserved may be determined and processed in the following two manners.

Manner 1: Determine the HARQ entity that needs to be reserved according to an agreed definition of the first HARQ entity.

The first HARQ entity includes at least one of the following:

B-1: An HARQ entity associated with a first source serving cell, where the first source serving cell meets the following condition: the first source serving cell is a serving cell of the terminal before and after the serving cell change is performed.

For example, before the terminal performs the serving cell change, a configured cell (including a primary cell (Primary Cell, PCell) and a secondary cell (Secondary Cell, SCell)) is: [PCell (Cell #1); SCell #1, SCell #2, SCell #3]. After the terminal performs the serving cell change, the configured cell is [PCell; SCell #A, SCell #B (Cell #1), SCell #3]. In this case, the cell #1 is a serving cell of the terminal before and after the serving cell change is performed, and an HARQ entity associated with cell #1 is the first HARQ entity.

B-2: An HARQ entity associated with a non-serving cell, where the non-serving cell is a non-serving cell on which the terminal performs inter-cell beam management ICBM (Inter-Cell Beam Management, ICBM) before receiving the serving cell change command, and is a cell for handover as indicated in the serving cell change command.

It may be understood that, when performing the ICBM, the terminal may use a neighboring cell (that is, a non-serving cell) to perform data transmission. In a case that the serving cell change command indicates to hand over the neighboring cell to the serving cell, the terminal may determine an HARQ entity associated with the neighboring cell as the first HARQ entity, to reduce data discarding caused by the serving cell change.

B-3: An HARQ entity associated with a second source serving cell in a case that the terminal performs a serving cell change within a distributed unit (Distributed Unit, DU), where the second source serving cell includes at least one of a primary cell, a PSCell, and a secondary cell.

It may be understood that, one DU may control a plurality of cells, and the plurality of cells are at the same MAC layer. Therefore, when the terminal performs the serving cell change in the DU, handover to the MAC layer is not involved. Therefore, the terminal may separately determine the HARQ entity associated with the second source serving cell at the same MAC layer as the first HARQ entity.

Manner 2: In a case that the terminal receives the serving cell change command, the terminal determines and processes the HARQ entity that needs to be reserved based on a protocol agreement or the received first indication information.

The terminal processes, based on a protocol agreement or the received first indication information, the HARQ entity of the source serving cell according to a first rule, where the first indication information indicates to reserve the HARQ entity of the source serving cell during the serving cell change.

The terminal reserves, according to the first rule, the HARQ entity indicated by the first indication information. Optionally, the terminal resets or reserves another HARQ entity of the source serving cell.

The first rule includes at least one of the following:
using an HARQ entity associated with a special cell of the second source serving cell as the first HARQ entity, and mapping the first HARQ entity to a special cell of the target serving cell; and
performing a reset operation on an HARQ entity associated with a non-source special cell, where the reset operation includes at least one of the following:
flushing HARQ buffers in all HARQ processes of the HARQ entity; and
setting NDIs in uplink HARQ processes of the HARQ entity to a value of 0.

During specific implementation, after performing the serving cell change, the terminal uses the first HARQ entity associated with the special cell of the second source serving cell as the HARQ entity associated with the special cell of the target serving cell, to implement mapping on the first HARQ entity. Optionally, the foregoing reset operation is performed on the HARQ entity associated with a non-source special cell, to delete the HARQ entity associated with the non-source special cell, and create a new HARQ entity for a non-special cell of the target serving cell.

Manner 3: In a case that the terminal receives the serving cell change command, the terminal maps an HARQ entity associated with the source serving cell with a mapping relationship indicated in first signaling to the target serving cell; or the terminal maps an HARQ entity associated with the source serving cell with a mapping relationship indicated in first signaling to the target serving cell, and performs a reset operation on an HARQ entity associated with the source serving cell without a mapping relationship indicated in the first signaling.

The target serving cell is a serving cell obtained after the terminal performs the serving cell change; and the first signaling includes the serving cell change command and/or RRC reconfiguration signaling. During specific implementation, the first signaling may include one or more of the following related information of the HARQ entity or cell related information, for example, an HARQ process ID, a cell index, and a physical cell identifier (Physical Cell Identifier, PCI).

It may be understood that, the network-side device may indicate, by using third target indication information carried in the serving cell change command, the terminal to determine the HARQ entity associated with the source serving cell as the first HARQ entity, to reserve the related HARQ entity. Alternatively, the network-side device may separately send first signaling to indicate an HARQ entity that needs to be mapped to the target serving cell, so that the terminal reserves or resets the related HARQ entity.

### Implementation 4

This implementation describes how to implement mapping of an HARQ entity in a case that carrier aggregation is configured for a terminal. There may be the following two cases based on a quantity of the source serving cells and a quantity of the target serving cells.

Case 1: in a case that carrier aggregation is configured for the terminal, and a quantity of source serving cells is less than or equal to a quantity of the target serving cells, the terminal maps, based on a cell index of the source serving cell and a cell index of the target serving cell, each HARQ entity associated with the source serving cell to the target serving cell in one-to-one correspondence; and determines the HARQ entity mapped to the target serving cell as the first HARQ entity, where the target serving cell is a serving cell obtained after the terminal performs the serving cell change.

During specific implementation, each HARQ entity associated with the source serving cell may be mapped to the target serving cell in one-to-one correspondence according to an ascending order of the cell indexes of the source serving cells and the cell indexes of the target serving cells. For example, the cell indexes of the source serving cells are 1, 3, and 4, and the cell indexes of the target serving cells are 3, 4, and 6. In this case, according to an ascending order of the indexes, the HARQ entities associated with the source serving cells with cell indexes of 1, 3, and 4 are sequentially mapped to the target serving cells with cell indexes of 3, 4, and 6.

Case 2: in a case that carrier aggregation is configured for the terminal, and a quantity of source serving cells is greater than a quantity of the target serving cells, the terminal maps, based on a cell index of the source serving cell and a cell index of the target serving cell, each HARQ entity associated with the source serving cell to the target serving cell in one-to-one correspondence; determines the HARQ entity mapped to the target serving cell as the first HARQ entity; and performs a reset operation on an HARQ entity that is not mapped to the target serving cell.

For example, the cell indexes of the source serving cells are 1, 3, 4, and 7; and the cell indexes of the target serving cells are 3, 4, and 6. In this case, according to an ascending order of the indexes, the HARQ entities associated with the source serving cells with cell indexes of 1, 3, and 4 are sequentially mapped to the target serving cells with cell indexes of 3, 4, and 6. Then, for the HARQ entity associated with the source serving cell with a cell index of 7, there is no target serving cell to which the HARQ entity can be mapped, and the HARQ entity may perform the reset operation.

In a possible implementation, that the terminal maps, based on the cell index of the source serving cell and the cell index of the target serving cell, each HARQ entity associated with the source serving cell to the target serving cell in one-to-one correspondence; and performs the reset operation on the HARQ entity not mapped to the target serving cell include either one of the following:

D-1: Mapping, based on the cell index of the source serving cell, HARQ entities associated with source serving cells corresponding to first N cell indexes to N target serving cells in one-to-one correspondence; determining the HARQ entities associated with the source serving cells corresponding to the first N cell indexes mapped to the target serving cells as the first HARQ entity; and performing a reset operation on an HARQ entity associated with a remaining source serving cell other than the first N source serving cells.

D-2: Mapping, based on a quantity of working HARQ processes of the HARQ entity associated with the source serving cell, first N HARQ entities associated with source serving cells to N target serving cells in one-to-one correspondence according to a first sequence; determining the first N HARQ entities associated with the source serving cells mapped to the target serving cells as the first HARQ entity; and performing a reset operation on an HARQ entity associated with a remaining source serving cell other than the first N source serving cells, where the first sequence is: a sequence determined based on the cell indexes, or a sequence determined based on the quantity of working HARQ processes of the HARQ entity, where the working HARQ process includes: an HARQ process with data in the HARQ buffer, and/or an HARQ process that is associated with unsuccessfully decoded data in the HARQ buffer, and/or, an HARQ process that is associated with successfully decoded data in the HARQ buffer for which no ACK indication information has been transmitted to a network-side device, and/or an HARQ process that is associated with successfully decoded data in the HARQ buffer and that has not been transmitted to the physical layer; and

N is a total quantity of cells included in the target serving cells, or N is a total quantity of active cells included in the target serving cells.

During specific implementation, the first N HARQ entities with a largest quantity of working HARQ processes may be sorted according to an order of the working HARQ processes, to obtain the first N HARQ entities associated with the N source serving cells. Then, the N HARQ entities are sequentially mapped to the first N target serving cells according to the order of the working HARQ processes of the N HARQ entities and an ascending order of the cell indexes of the target serving cells. Alternatively, after the N HARQ entities are obtained according to the order of the working HARQ processes, the N HARQ entities may be mapped to the N target serving cells in one-to-one correspondence according to the order of the cell indexes of the source serving cells and the target serving cells.

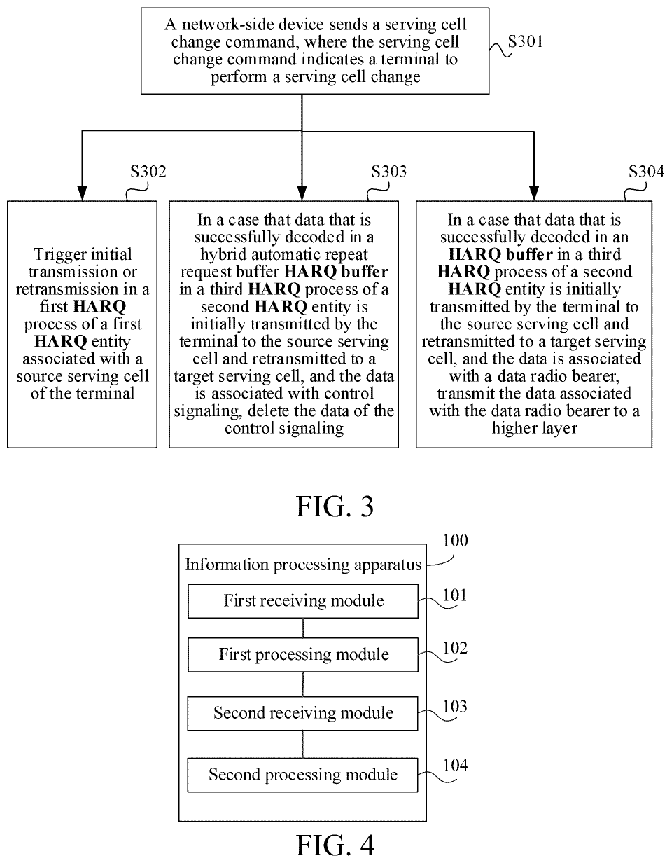

According to a second aspect, as shown in FIG. 3, an embodiment of this application provides another information processing method. The method at least includes the following steps.

Step S301: A network-side device sends a serving cell change command, where the serving cell change command indicates a terminal to perform a serving cell change.

After performing the serving cell change, the network-side device performs at least one of step S302 to step S304.

Step S302: Trigger initial transmission or retransmission in a first HARQ process of a first HARQ entity associated with a source serving cell of the terminal.

Step S303: In a case that data that is successfully decoded in a hybrid automatic repeat request buffer HARQ buffer in a third HARQ process of a second HARQ entity is initially transmitted by the terminal to the source serving cell and retransmitted to a target serving cell, and the data is associated with control signaling, delete the data of the control signaling.

Step S304: In a case that data that is successfully decoded in an HARQ buffer in a third HARQ process of a second HARQ entity is initially transmitted by the terminal to the source serving cell and retransmitted to a target serving cell, and the data is associated with a data radio bearer, transmit the data associated with the data radio bearer to a higher layer.

The source serving cell is a serving cell obtained before the terminal performs the serving cell change, and the target serving cell is a serving cell obtained after the terminal performs the serving cell change.

In a possible implementation, that the network-side device triggers initial transmission or retransmission in the first HARQ process of the first HARQ entity associated with the source serving cell of the terminal includes:
the network-side device triggers initial transmission in the first HARQ process in a case that the source serving cell receives ACK indication information from the terminal for data in a TB associated with the first HARQ process of the source serving cell, or the data in the HARQ buffer in the first HARQ process is associated with the control signaling; and
the network-side device triggers retransmission in the first HARQ process in a case that the source serving cell does not receive ACK indication information from the terminal for data in a TB associated with the first HARQ process of the source serving cell, or the source serving cell receives NACK indication information from the terminal for data in a TB associated with the first HARQ process of the source serving cell.

In a possible implementation, that the network-side device triggers initial transmission or retransmission in the first HARQ process of the first HARQ entity associated with the source serving cell of the terminal includes:
the network-side device sends, to the terminal before the terminal performs the serving cell change, an uplink grant for the first HARQ process or a configuration grant with the first HARQ process, and in a case that the source serving cell correctly receives corresponding data sent by the terminal, the network-side device triggers initial transmission in the first HARQ process after the terminal performs the serving cell change; and
the network-side device sends, to the terminal before the terminal performs the serving cell change, an uplink grant for the first HARQ process or a configuration grant with the first HARQ process, and in a case that the source serving cell does not receive corresponding data sent by the terminal, the network-side device triggers retransmission in the first HARQ process after the terminal performs the serving cell change.

In a possible implementation, that the network-side device triggers initial transmission or retransmission in the first HARQ process of the first HARQ entity associated with the source serving cell includes:
the network-side device sends a first uplink grant or a first downlink assignment to the terminal, where an NDI in HARQ information in the first HARQ process that is included in the first uplink grant or the first downlink assignment is toggled; or
the network-side device sends a second uplink grant or a second downlink assignment to the terminal, where an NDI in HARQ information in the first HARQ process that is included in the second uplink grant or the second downlink assignment is not toggled.

The information processing method according to embodiments of this application may be performed by an information processing apparatus. In embodiments of this application, the information processing apparatus according to embodiments of this application is described by using an example in which the information processing apparatus performs the information processing method.

According to a third aspect, an embodiment of this application provides an information processing apparatus, and the apparatus is executed by a terminal. As shown in FIG. 4, the information processing apparatus 100 includes:
a first receiving module 101, configured to receive a serving cell change command, where the serving cell change command indicates the terminal to perform a serving cell change;
a first processing module 102, configured to perform the serving cell change;
a second receiving module 103, configured to receive, after performing the serving cell change, retransmitted data of a source serving cell from a target serving cell based on HARQ information indicated in a downlink assignment that is received by the target serving cell; and
a second processing module 104, configured to: in a case that the terminal stores unsuccessfully decoded data of the source serving cell in an HARQ buffer in a first HARQ process of a first HARQ entity, combine the unsuccessfully decoded data of the source serving cell and the retransmitted data of the source serving cell received from the target serving cell, and decode the combined data, where the unsuccessfully decoded data is new transmitted data or the retransmitted data of the source serving cell, where
the target serving cell is a serving cell obtained after the terminal performs the serving cell change, and the source serving cell is a serving cell obtained before the terminal performs the serving cell change.

Optionally, in a case that the combined data is successfully decoded, the apparatus further includes:
a third processing module, configured to perform at least one of the following operations on the decoded combined data:
delete the decoded combined data in a case that the decoded combined data is associated with control signaling; or
reserve the decoded combined data in a case that the decoded combined data is associated with a data radio bearer DRB.

Optionally, the apparatus further includes either one of the following:
a fourth processing module, configured to: in a case that the terminal stores successfully decoded data of the source serving cell in the HARQ buffer in the first HARQ process, and the terminal receives, from the target serving cell, the downlink assignment indicating retransmission of the first HARQ process, indicate, by a medium access control MAC layer entity of the terminal, a physical layer to send ACK indication information for data in a transport block TB associated with the first HARQ process; or
a fifth processing module, configured to: in a case that the terminal successfully decodes the data that is obtained after the terminal combines the data in the HARQ buffer in the first HARQ process and the retransmitted data of the source serving cell received from the target serving cell, indicate, by a MAC layer entity of the terminal, a physical layer to send ACK indication information for data in a TB associated with the first HARQ process.

Optionally, upon a failure to decode the data that is obtained after the terminal combines the data in the HARQ buffer in the first HARQ process and the retransmitted data of the source serving cell received from the target serving cell, the apparatus further includes:
a sixth processing module, configured to store the retransmitted data of the source serving cell received from the target serving cell in the HARQ buffer in the first HARQ process, and/or indicate, by the MAC layer entity of the terminal, the physical layer to send NACK indication information for the data in the TB associated with the first HARQ process.

Optionally, the apparatus further includes:
a seventh processing module, configured to perform a first operation on the first HARQ entity during an interval between receiving the serving cell change command and performing the serving cell change, where the first operation includes at least one of the following:
in a case that data that is successfully decoded in a hybrid automatic repeat request buffer HARQ buffer in a second HARQ process of the first HARQ entity is associated with the control signaling, delete the data associated with the control signaling;
send, by the media access MAC layer entity of the terminal, first target indication information to a radio resource control RRC layer, and indicate, by the RRC based on the first target indication information, a PDCP entity and an RLC entity associated with a signaling radio bearer SRB to flush stored data, where the first target indication information indicates that UE performs the serving cell change;
in a case that data that is successfully decoded in an HARQ buffer in the second HARQ process is associated with the data radio bearer of the source serving cell, transmit the data associated with the data radio bearer of the source serving cell to a higher layer; and
reserve data and HARQ information in an HARQ buffer in the second HARQ process.

Optionally, that the data is associated with the control signaling includes:
a MAC subPDU included in a MAC PDU is associated with the signaling radio bearer SRB.

Optionally, the SRB includes at least one of the following: an SRB 1, an SRB 2, an SRB 3, and an SRB 4.

Optionally, the first HARQ entity includes at least one of the following:
an HARQ entity associated with a first source serving cell, where the first source serving cell meets the following condition: the first source serving cell is a serving cell of the terminal before and after the serving cell change is performed;
an HARQ entity associated with a non-serving cell, where the non-serving cell is a non-serving cell on which the terminal performs inter-cell beam management ICBM before receiving the serving cell change command, and is a cell for handover as indicated in the serving cell change command; and
an HARQ entity associated with a second source serving cell in a case that the terminal performs a serving cell change within a distributed unit DU, where the second source serving cell includes at least one of a primary cell, a PSCell, and a secondary cell.

Optionally, in a case that the terminal receives the serving cell change command, the apparatus further includes:
an eighth processing module, configured to process, based on a protocol agreement or the received first indication information, the HARQ entity of the source serving cell according to a first rule, where the first indication information indicates to reserve the HARQ entity of the source serving cell during the serving cell change, where
the first rule includes at least one of the following:
using an HARQ entity associated with a special cell of the second source serving cell as the first HARQ entity, and mapping the first HARQ entity to a special cell of the target serving cell; and
performing a reset operation on an HARQ entity associated with a non-source special cell, where the reset operation includes at least one of the following:
flushing HARQ buffers in all HARQ processes of the HARQ entity; and
setting NDIs in uplink HARQ processes of the HARQ entity to a value of 0.

Optionally, in a case that carrier aggregation is configured for the terminal, and a quantity of source serving cells is less than or equal to a quantity of target serving cells, the eighth processing module includes:
a first processing sub-module, configured to: map, based on a cell index of the source serving cell and a cell index of the target serving cell, each HARQ entity associated with the source serving cell to the target serving cell in one-to-one correspondence; and determine the HARQ entity mapped to the target serving cell as the first HARQ entity, where the target serving cell is a serving cell obtained after the terminal performs the serving cell change.

Optionally, in a case that carrier aggregation is configured for the terminal, and a quantity of source serving cells is greater than a quantity of target serving cells, the eighth processing module includes:
a second processing sub-module, configured to: map, based on a cell index of the source serving cell and a cell index of the target serving cell, each HARQ entity associated with the source serving cell to the target serving cell in one-to-one correspondence; determine the HARQ entity mapped to the target serving cell as the first HARQ entity; and perform a reset operation on an HARQ entity not mapped to the target serving cell, where the target serving cell is a serving cell obtained after the terminal performs the serving cell change.

Optionally, the second processing sub-module includes either one of the following:
a third processing sub-module, configured to: map, based on the cell index of the source serving cell, HARQ entities associated with source serving cells corresponding to first N cell indexes to N target serving cells in one-to-one correspondence; determine the HARQ entities associated with the source serving cells corresponding to the first N cell indexes mapped to the target serving cells as the first HARQ entity; and perform a reset operation on an HARQ entity associated with a remaining source serving cell other than the first N source serving cells; or
a fourth processing sub-module, configured to: map, based on a quantity of working HARQ processes of the HARQ entity associated with the source serving cell, first N HARQ entities associated with source serving cells to N target serving cells in one-to-one correspondence according to a first sequence; determine the first N HARQ entities associated with the source serving cells mapped to the target serving cells as the first HARQ entity; and perform a reset operation on an HARQ entity associated with a remaining source serving cell other than the first N source serving cells, where the first sequence is: a sequence determined based on the cell indexes, or a sequence determined based on the quantity of working HARQ processes of the HARQ entity, where the working HARQ process includes: an HARQ process with data in the HARQ buffer, and/or an HARQ process that is associated with unsuccessfully decoded data in the HARQ buffer, and/or, an HARQ process that is associated with successfully decoded data in the HARQ buffer for which no ACK indication information has been transmitted to a network-side device, and/or an HARQ process that is associated with successfully decoded data in the HARQ buffer and that has not been transmitted to the physical layer; and
N is a total quantity of cells included in the target serving cells, or N is a total quantity of active cells included in the target serving cells.

Optionally, in a case that the terminal receives the serving cell change command, the apparatus further includes:
a ninth processing module, configured to map an HARQ entity associated with the source serving cell with a mapping relationship indicated in first signaling to the target serving cell; or configured to: map an HARQ entity associated with the source serving cell with a mapping relationship indicated in first signaling to the target serving cell, and perform a reset operation on an HARQ entity associated with the source serving cell without a mapping relationship indicated in the first signaling, where
the target serving cell is a serving cell obtained after the terminal performs the serving cell change; and the first signaling includes the serving cell change command and/or RRC reconfiguration signaling.

Optionally, in a case that the terminal receives the serving cell change command, the apparatus further includes:
a tenth processing module, configured to: in a case that the serving cell change command carries second target indication information, determine the HARQ entity associated with the source serving cell as the first HARQ entity, where
the second target indication information indicates at least one of the following: a DU serving cell change, MAC layer reservation, HARQ reservation, and L2 reservation; and
the serving cell change command includes at least one of the following: a handover command, a PSCell switch command, a secondary cell handover command, L1/L2-triggered mobility signaling L1/L2-triggered mobility.

The information processing apparatus according to this embodiment of this application may implement all processes implemented in the information processing method in the embodiment according to the first aspect, and achieve the same technical effects. To avoid repetition, details are not described herein again.

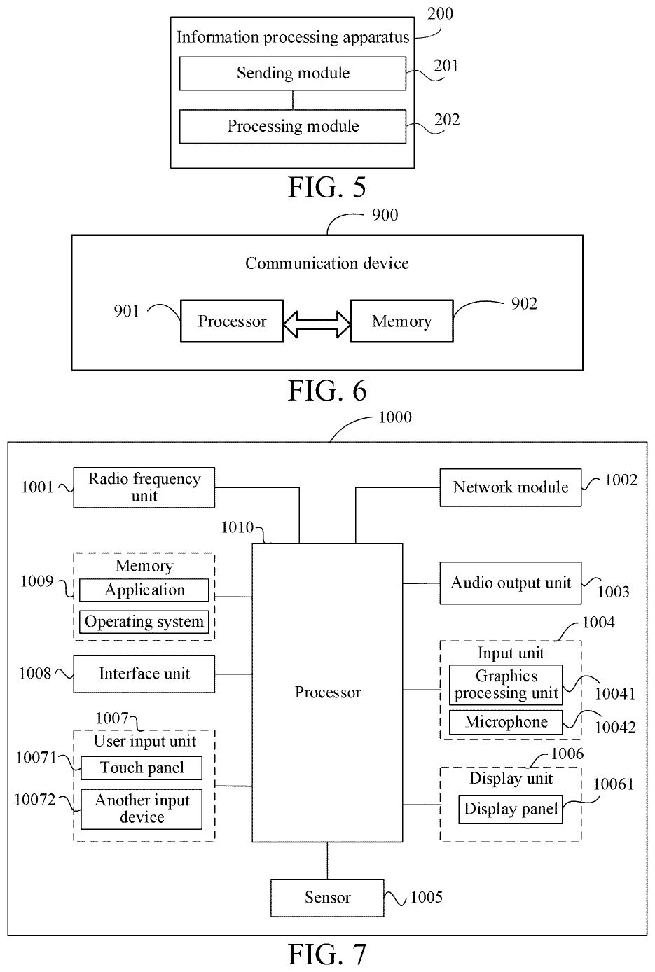

According to a fourth aspect, an embodiment of this application provides another information processing apparatus, and the apparatus is executed by a network-side device. As shown in FIG. 5, the information processing apparatus 200 includes:
a sending module 201, configured to send a serving cell change command, where the serving cell change command indicates a terminal to perform a serving cell change;
a processing module 202, configured to: after performing the serving cell change, perform at least one of the following:
trigger initial transmission or retransmission in a first HARQ process of a first HARQ entity associated with a source serving cell of the terminal;
in a case that data that is successfully decoded in a hybrid automatic repeat request buffer HARQ buffer in a third HARQ process of a second HARQ entity is initially transmitted by the terminal to the source serving cell and retransmitted to a target serving cell, and the data is associated with control signaling, delete the data of the control signaling; and
in a case that data that is successfully decoded in an HARQ buffer in a third HARQ process of a second HARQ entity is initially transmitted by the terminal to the source serving cell and retransmitted to a target serving cell, and the data is associated with a data radio bearer, transmit the data associated with the data radio bearer to a higher layer, where
the source serving cell is a serving cell obtained before the terminal performs the serving cell change, and the target serving cell is a serving cell obtained after the terminal performs the serving cell change.

Optionally, the processing module 202 includes:
a first execution module, configured to: trigger initial transmission in the first HARQ process in a case that the source serving cell receives ACK indication information from the terminal for data in a TB associated with the first HARQ process of the source serving cell, or the data in the HARQ buffer in the first HARQ process is associated with the control signaling; and
a second execution module, configured to: trigger retransmission in the first HARQ process in a case that the source serving cell does not receive ACK indication information from the terminal for data in a TB associated with the first HARQ process of the source serving cell, or the source serving cell receives NACK indication information from the terminal for data in a TB associated with the first HARQ process of the source serving cell.

Optionally, the processing module 202 includes:
a third execution module, configured to: send, to the terminal before the terminal performs the serving cell change, an uplink grant for the first HARQ process or a configuration grant with the first HARQ process, and in a case that the source serving cell receives corresponding data sent by the terminal, trigger initial transmission in the first HARQ process after the terminal performs the serving cell change; and
a fourth execution module, configured to: send, to the terminal before the terminal performs the serving cell change, an uplink grant for the first HARQ process or a configuration grant with the first HARQ process, and in a case that the source serving cell does not receive corresponding data sent by the terminal, trigger retransmission in the first HARQ process after the terminal performs the serving cell change.

Optionally, the processing module 202 further includes:
a fifth execution module, configured to send a first uplink grant or a first downlink assignment to the terminal, where an NDI in HARQ information in the first HARQ process that is included in the first uplink grant or the first downlink assignment is toggled; or
a sixth execution module, configured to send a second uplink grant or a second downlink assignment to the terminal, where an NDI in HARQ information in the first HARQ process that is included in the second uplink grant or the second downlink assignment is not toggled.

The information processing apparatus according to this embodiment of this application may implement all processes implemented in the information processing method in the embodiment according to the second aspect, and achieve the same technical effects. To avoid repetition, details are not described herein again.

Optionally, as shown in FIG. 6, an embodiment of this application further provides a communication device 900, including a processor 901 and a memory 902. The memory 902 stores a program or instructions that can be run on the processor 901. For example, when the communication device 900 is a terminal, and the program or the instructions are executed by the processor 901, steps of the information processing method in the embodiment according to the first aspect are implemented and the same technical effects can be achieved. When the communication device 900 is a network-side device, and the program or the instructions are executed by the processor 901, steps of the information processing method in the embodiment according to the second aspect are implemented and the same technical effects can be achieved. To avoid repetition, details are not described herein again.

FIG. 7 is a diagram of a hardware structure of a terminal according to an embodiment of this application.

The terminal 1000 is configured to implement steps of the information processing method in the embodiment according to the first aspect, and the same technical effects can be achieved. The terminal 1000 includes but is not limited to: at least some of components of a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

A person skilled in the art may understand that, the terminal 1000 may further include a power supply (for example, a battery) for supplying power to the components. The power supply may be logically connected to the processor 1010 by using a power management system, to implement functions such as charging, discharging, and power consumption management by using the power management system. The structure of the terminal shown in FIG. 7 constitutes no limitation on the terminal. The terminal may include more or fewer components than those shown in the figure, or combine some components, or have different component arrangements. Details are not described herein again.

It should be understood that, in this embodiment of this application, the input unit 1004 may include a graphics processing unit (Graphics Processing Unit, GPU) 10041 and a microphone 10042. The graphics processing unit 10041 performs processing on image data of a static image or a video that is obtained by an image capture device (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is alternatively referred to as a touchscreen. The touch panel 10071 may include two parts: a touch detection apparatus and a touch controller. The another input device 10072 may include, but is not limited to, a physical keyboard, a function button (for example, a volume control button, a power button, or the like), a trackball, a mouse, and a joystick. Details are not described herein again.

In this embodiment of this application, after receiving downlink data from a network-side device, the radio frequency unit 1001 may transmit the downlink data to the processor 1010 for processing. In addition, the radio frequency unit 1001 may send uplink data to the network-side device. Generally, the radio frequency unit 1001 includes, but is not limited to, an antenna, an amplifier, a transceiver, a coupler, a low noise amplifier, a duplexer, and the like.

The memory 1009 may be configured to store a software program or instructions and various data. The memory 1009 may mainly include a first storage area for storing the program and the instructions and a second storage area for storing the data. The first storage area may store an operating system, an application or instructions required by at least one function (for example, a sound playback function, an image display function, and the like), and the like. In addition, the memory 1009 may include a volatile memory or a non-volatile memory, or the memory 1009 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DRRAM). The memory 1009 in this embodiment of this application includes, but is not limited to, these memories and any memory of another proper type.

The processor 1010 may include one or at least two processing units. Optionally, the processor 1010 integrates an application processor and a modem processor. The application processor mainly processes an operation related to an operating system, a user interface, an application, and the like; and the modem processor mainly processes a wireless communication signal, for example, a baseband processor. It may be understood that, the foregoing modem processor may not be integrated into the processor 1010.

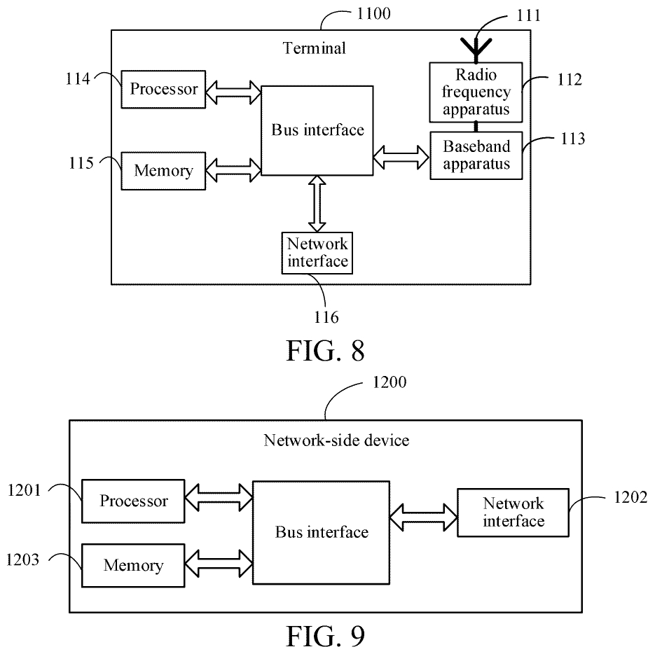

An embodiment of this application further provides a terminal. As shown in FIG. 8, the terminal 1100 includes: an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111 and sends the received information to the baseband apparatus 113 for processing. In a downlink direction, the baseband apparatus 113 processes to-be-sent information and sends the information to the radio frequency apparatus 112, and the radio frequency apparatus 112 processes the received information and sends the information through the antenna 111.

The information processing method performed by the terminal in the foregoing embodiment may be implemented in the baseband apparatus 113, and the baseband apparatus 113 includes a baseband processor.

The baseband apparatus 113 may include, for example, at least one baseband board. At least two chips are disposed on the baseband board. As shown in FIG. 8, one chip is, for example, a baseband processor, connected to the memory 115 through a bus interface, to invoke a program in the memory 115, and perform an operation performed by the network-side device shown in the foregoing information processing method in the embodiment according to the first aspect.

The terminal may further include a network interface 116, and the interface is, for example, a common public radio interface (Common Public Radio Interface, CPRI).

Specifically, the terminal 1100 in this embodiment of the present invention further includes: instructions or a program stored in the memory 115 and can be run on the processor 114. The processor 114 calls the instructions or the program in the memory 115 to perform the information processing method according to the first aspect, and the same technical effects are achieved. To avoid repetition, details are not described herein again.

An embodiment of this application further provides a network-side device. As shown in FIG. 9, the network-side device 1200 includes: a processor 1201, a network interface 1202, and a memory 1203. The network interface 1202 is, for example, a common public radio interface (Common Public Radio Interface, CPRI).

Specifically, the network-side device 1200 in this embodiment of the present invention further provides: instructions or a program stored in the memory 1203 and can be run on the processor 1201. The processor 1201 calls the instructions or the program in the memory 1203 to perform the information processing method according to the second aspect, and the same technical effects are achieved. To avoid repetition, details are not described herein again.

An embodiment of this application further provides a readable storage medium. The readable storage medium stores a program or instructions, and when the program or the instructions are executed by a processor, all processes of the information processing method in the embodiment are implemented, and the same technical effects can be achieved. To avoid repetition, details are not described herein again.

The processor is a processor in the terminal device described in the foregoing embodiments. The readable storage medium includes a computer-readable storage medium, for example, a computer read-only memory ROM, a random access memory RAM, a magnetic or an optical disc, and the like. In some examples, the readable storage medium may be a non-transient readable storage medium,

An embodiment of this application further provides a chip. The chip includes a processor and a communication interface. The communication interface is coupled to the processor, and the processor is configured to run a program or instructions, to implement all processes of the information processing method in the embodiment, and the same technical effects can be achieved. To avoid repetition, details are not described herein again.

It should be understood that, the chip in this embodiment of this application may alternatively be referred to as a system-level chip, a system chip, a chip system, a system-on-chip, or the like.

An embodiment of this application further provides a computer program/program product. The computer program/program product is stored in a storage medium. The computer program/program product is executed by at least one processor, to implement all processes of the information processing method in the embodiment, and the same technical effects can be achieved. To avoid repetition, details are not described herein again.

An embodiment of this application further provides an information processing system, including: a network-side device and a terminal, where the terminal is configured to perform steps of the information processing method according to the first aspect, and the network-side device is configured to perform steps of the information processing method according to the second aspect.

It should be noted that, the terms “include”, “comprise”, or any other variation thereof in this specification is intended to cover a non-exclusive inclusion, so that a process, a method, an article, or an apparatus that includes a list of elements not only includes those elements but also includes other elements that are not expressly listed, or further includes elements inherent to such a process, a method, an article, or an apparatus. An element preceded by “includes a” does not, without more constraints, preclude the presence of additional identical elements in the process, the method, the article, or the apparatus that includes the element. In addition, it should be noted that, scopes of the method and the apparatus in the implementations of this application are not limited to performing functions in an order shown or discussed, but may include performing functions in a substantially concurrent manner or in reverse order depending on functionality involved. For example, the methods described may be performed in an order different from that described, and various steps may alternatively be added, omitted, or combined. In addition, features described with reference to some examples may alternatively be combined in another example.

According to the descriptions of the foregoing implementations, a person skilled in the art may clearly learn that the method according to the foregoing embodiment may be implemented by a computer software product in addition to a necessary universal hardware platform, or by using hardware. In many cases, the former is a better implementation. Based on such an understanding, the technical solutions of this application essentially, or the part contributing to the conventional technology, may be presented in a form of a computer software product. The computer software product is stored in a storage medium (for example, a ROM, a RAM, a magnetic disk, an optical disc, or the like) including several instructions to enable a terminal or a network-side device to perform the methods described in embodiments of this application.

Embodiments of this application are described with reference to the accompanying drawings. This application is not limited to the specific implementations described above, and the specific implementations described above are merely examples and not limited. A person of ordinary skill in the art may also make various forms of implementations under the inspiration of this application and without departing from the purpose of this application and the protection scope of the claims, and such implementations shall all fall within the protection scope of this application.

What is claimed is:

1. An information processing method, comprising:
receiving, by a terminal, a serving cell change command, wherein the serving cell change command indicates the terminal to perform a serving cell change;
performing, by the terminal, the serving cell change;
receiving, by the terminal after performing the serving cell change, retransmitted data of a source serving cell from a target serving cell based on HARQ information indicated in a downlink assignment that is received by the target serving cell; and
in a case that the terminal stores unsuccessfully decoded data of the source serving cell in an HARQ buffer in a first HARQ process of a first HARQ entity, combining the unsuccessfully decoded data of the source serving cell and the retransmitted data of the source serving cell received from the target serving cell, and decoding the combined data, wherein the unsuccessfully decoded data is new transmitted data or the retransmitted data of the source serving cell, wherein
the target serving cell is a serving cell obtained after the terminal performs the serving cell change, and the source serving cell is a serving cell obtained before the terminal performs the serving cell change.

2. The method according to claim 1, wherein in a case that the combined data is successfully decoded, the method further comprises:
performing, by the terminal, at least one of the following operations on the decoded combined data:
deleting the decoded combined data in a case that the decoded combined data is associated with control signaling; or
reserving the decoded combined data in a case that the decoded combined data is associated with a data radio bearer DRB.

3. The method according to claim 1, wherein the method further comprises either one of the following:
in a case that the terminal stores successfully decoded data of the source serving cell in the HARQ buffer in the first HARQ process, and the terminal receives, from the target serving cell, the downlink assignment indicating retransmission of the first HARQ process, indicating, by a medium access control MAC layer entity of the terminal, a physical layer to send ACK indication information for data in a transport block TB associated with the first HARQ process; or
in a case that the terminal successfully decodes the data that is obtained after the terminal combines the data in the HARQ buffer in the first HARQ process and the retransmitted data of the source serving cell received from the target serving cell, indicating, by a MAC layer entity of the terminal, a physical layer to send ACK indication information for data in a TB associated with the first HARQ process.

4. The method according to claim 1, wherein upon a failure to decode the data that is obtained after the terminal combines the data in the HARQ buffer in the first HARQ process and the retransmitted data of the source serving cell received from the target serving cell, the method further comprises:
storing, by the terminal, the retransmitted data of the source serving cell received from the target serving cell in the HARQ buffer in the first HARQ process, and/or indicating, by the MAC layer entity of the terminal, the physical layer to send NACK indication information for the data in the TB associated with the first HARQ process.

5. The method according to claim 1, wherein the method further comprises:
performing, by the terminal, a first operation on the first HARQ entity during an interval between receiving the serving cell change command and performing the serving cell change, wherein the first operation comprises at least one of the following:
in a case that data that is successfully decoded in a hybrid automatic repeat request buffer HARQ buffer in a second HARQ process of the first HARQ entity is associated with the control signaling, deleting the data associated with the control signaling;
sending, by the media access MAC layer entity of the terminal, first target indication information to a radio resource control RRC layer, and indicating, by the RRC based on the first target indication information, a PDCP entity and an RLC entity associated with a signaling radio bearer SRB to flush stored data, wherein the first target indication information indicates that UE performs the serving cell change;
in a case that data that is successfully decoded in the HARQ buffer in the second HARQ process is associated with the data radio bearer of the source serving cell, transmitting the data associated with the data radio bearer of the source serving cell to a higher layer; and
reserving data and HARQ information in the HARQ buffer in the second HARQ process.

6. The method according to claim 2, wherein that the data is associated with the control signaling comprises:
a MAC subPDU comprised in a MAC PDU is associated with the signaling radio bearer SRB.

7. The method according to claim 6, wherein the SRB comprises at least one of the following:
an SRB 1, an SRB 2, an SRB 3, and an SRB 4.

8. The method according to claim 1, wherein the first HARQ entity comprises at least one of the following:
an HARQ entity associated with a first source serving cell, wherein the first source serving cell meets the following condition: the first source serving cell is a serving cell of the terminal before and after the serving cell change is performed;
an HARQ entity associated with a non-serving cell, wherein the non-serving cell is a non-serving cell on which the terminal performs inter-cell beam management ICBM before receiving the serving cell change command, and is a cell for handover as indicated in the serving cell change command; and
an HARQ entity associated with a second source serving cell in a case that the terminal performs a serving cell change within a distributed unit DU, wherein the second source serving cell comprises at least one of a primary cell, a PSCell, and a secondary cell.

9. The method according to claim 1 wherein in a case that the terminal receives the serving cell change command, the method further comprises:
processing, by the terminal based on a protocol agreement or the received first indication information, the HARQ entity of the source serving cell according to a first rule, wherein the first indication information indicates to reserve the HARQ entity of the source serving cell during the serving cell change, wherein
the first rule comprises at least one of the following:
using an HARQ entity associated with a special cell of the second source serving cell as the first HARQ entity, and mapping the first HARQ entity to a special cell of the target serving cell; and
performing a reset operation on an HARQ entity associated with a non-source special cell, wherein the reset operation comprises at least one of the following:
flushing HARQ buffers in all HARQ processes of the HARQ entity; and
setting NDIs in uplink HARQ processes of the HARQ entity to a value of 0.

10. The method according to claim 9, wherein in a case that carrier aggregation is configured for the terminal, and a quantity of source serving cells is less than or equal to a quantity of target serving cells, processing, by the terminal, the HARQ entity of the source serving cell according to the first rule comprises:
mapping, by the terminal based on a cell index of the source serving cell and a cell index of the target serving cell, each HARQ entity associated with the source serving cell to the target serving cell in one-to-one correspondence; and determining the HARQ entity mapped to the target serving cell as the first HARQ entity, wherein the target serving cell is a serving cell obtained after the terminal performs the serving cell change, or
wherein in a case that carrier aggregation is configured for the terminal, and a quantity of source serving cells is greater than a quantity of target serving cells, processing, by the terminal, the HARQ entity of the source serving cell according to the first rule comprises:
mapping, by the terminal based on a cell index of the source serving cell and a cell index of the target serving cell, each HARQ entity associated with the source serving cell to the target serving cell in one-to-one correspondence; determining the HARQ entity mapped to the target serving cell as the first HARQ entity; and performing a reset operation on an HARQ entity not mapped to the target serving cell, wherein the target serving cell is a serving cell obtained after the terminal performs the serving cell change.

11. The method according to claim 10, wherein mapping, by the terminal based on the cell index of the source serving cell and the cell index of the target serving cell, each HARQ entity associated with the source serving cell to the target serving cell in one-to-one correspondence; and performing the reset operation on the HARQ entity not mapped to the target serving cell comprise either one of the following:
mapping, based on the cell index of the source serving cell, HARQ entities associated with source serving cells corresponding to first N cell indexes to N target serving cells in one-to-one correspondence; determining the HARQ entities associated with the source serving cells corresponding to the first N cell indexes mapped to the target serving cells as the first HARQ entity; and performing a reset operation on an HARQ entity associated with a remaining source serving cell other than the first N source serving cells; or
mapping, based on a quantity of working HARQ processes of the HARQ entity associated with the source serving cell, first N HARQ entities associated with source serving cells to N target serving cells in one-to-one correspondence according to a first sequence; determining the first N HARQ entities associated with the source serving cells mapped to the target serving cells as the first HARQ entity; and performing a reset operation on an HARQ entity associated with a remaining source serving cell other than the first N source serving cells, wherein the first sequence is: a sequence determined based on the cell indexes, or a sequence determined based on the quantity of working HARQ processes of the HARQ entity, wherein the working HARQ process comprises: an HARQ process with data in the HARQ buffer, and/or an HARQ process that is associated with unsuccessfully decoded data in the HARQ buffer, and/or, an HARQ process that is associated with successfully decoded data in the HARQ buffer for which no ACK indication information has been transmitted to a network-side device, and/or an HARQ process that is associated with successfully decoded data in the HARQ buffer and that has not been transmitted to the physical layer; and
N is a total quantity of cells comprised in the target serving cells, or N is a total quantity of active cells comprised in the target serving cells.

12. The method according to claim 1, wherein in a case that the terminal receives the serving cell change command, the method further comprises:
mapping, by the terminal, an HARQ entity associated with the source serving cell with a mapping relationship indicated in first signaling to the target serving cell; or
mapping, by the terminal, an HARQ entity associated with the source serving cell with a mapping relationship indicated in first signaling to the target serving cell, and performing a reset operation on an HARQ entity associated with the source serving cell without a mapping relationship indicated in the first signaling, wherein
the target serving cell is a serving cell obtained after the terminal performs the serving cell change; and the first signaling comprises the serving cell change command and/or RRC reconfiguration signaling.

13. The method according to claim 1, wherein in a case that the terminal receives the serving cell change command, the method further comprises:
in a case that the serving cell change command carries second target indication information, determining the HARQ entity associated with the source serving cell as the first HARQ entity, wherein
the second target indication information indicates at least one of the following: a DU serving cell change, MAC layer reservation, HARQ reservation, and L2 reservation; and
the serving cell change command comprises at least one of the following: a handover command, a PSCell switch command, a secondary cell handover command, L1/L2-triggered mobility mobility signaling L1/L2-triggered mobility.

14. An information processing method, comprising:
sending, by a network-side device, a serving cell change command, wherein the serving cell change command indicates a terminal to perform a serving cell change;
after performing the serving cell change, performing, by the network-side device, at least one of the following:
triggering initial transmission or retransmission in a first HARQ process of a first HARQ entity associated with a source serving cell of the terminal;
in a case that data that is successfully decoded in a hybrid automatic repeat request buffer HARQ buffer in a third HARQ process of a second HARQ entity is initially transmitted by the terminal to the source serving cell and retransmitted to a target serving cell, and the data is associated with control signaling, deleting the data of the control signaling; and
in a case that data that is successfully decoded in an HARQ buffer in a third HARQ process of a second HARQ entity is initially transmitted by the terminal to the source serving cell and retransmitted to a target serving cell, and the data is associated with a data radio bearer, transmitting the data associated with the data radio bearer to a higher layer, wherein
the source serving cell is a serving cell obtained before the terminal performs the serving cell change, and the target serving cell is a serving cell obtained after the terminal performs the serving cell change.

15. The method according to claim 14, wherein triggering, by the network-side device, initial transmission or retransmission in the first HARQ process of the first HARQ entity associated with the source serving cell of the terminal comprises:
triggering, by the network-side device, initial transmission in the first HARQ process in a case that the source serving cell receives ACK indication information from the terminal for data in a TB associated with the first HARQ process of the source serving cell, or the data in the HARQ buffer in the first HARQ process is associated with the control signaling; and
triggering, by the network-side device, retransmission in the first HARQ process in a case that the source serving cell does not receive ACK indication information from the terminal for data in a TB associated with the first HARQ process of the source serving cell, or the source serving cell receives NACK indication information from the terminal for data in a TB associated with the first HARQ process of the source serving cell.

16. The method according to claim 14, wherein triggering, by the network-side device, initial transmission or retransmission in the first HARQ process of the first HARQ entity associated with the source serving cell of the terminal comprises:
sending, by the network-side device to the terminal before the terminal performs the serving cell change, an uplink grant for the first HARQ process or a configuration grant with the first HARQ process, and in a case that the source serving cell receives corresponding data sent by the terminal, triggering initial transmission in the first HARQ process after the terminal performs the serving cell change; and
sending, by the network-side device to the terminal before the terminal performs the serving cell change, an uplink grant for the first HARQ process or a configuration grant with the first HARQ process, and in a case that the source serving cell does not receive corresponding data sent by the terminal, triggering retransmission in the first HARQ process after the terminal performs the serving cell change.

17. The method according to claim 14, wherein triggering, by the network-side device, initial transmission or retransmission in the first HARQ process of the first HARQ entity associated with the source serving cell comprises:
sending, by the network-side device, a first uplink grant or a first downlink assignment to the terminal, wherein an NDI in HARQ information in the first HARQ process that is comprised in the first uplink grant or the first downlink assignment is toggled; or
sending, by the network-side device, a second uplink grant or a second downlink assignment to the terminal, wherein an NDI in HARQ information in the first HARQ process that is comprised in the second uplink grant or the second downlink assignment is not toggled.

18. The method according to claim 14, wherein that the data is associated with the control signaling comprises:
a MAC subPDU comprised in a MAC PDU is associated with a signaling radio bearer SRB.

19. A terminal, comprising a processor and a memory, wherein the memory stores a program or instructions that can be run on the processor, and the program or the instructions, when executed by the processor, implement steps of:
receiving a serving cell change command, wherein the serving cell change command indicates the terminal to perform a serving cell change;
performing the serving cell change;
receiving, after performing the serving cell change, retransmitted data of a source serving cell from a target serving cell based on HARQ information indicated in a downlink assignment that is received by the target serving cell; and
in a case that the terminal stores unsuccessfully decoded data of the source serving cell in an HARQ buffer in a first HARQ process of a first HARQ entity, combining the unsuccessfully decoded data of the source serving cell and the retransmitted data of the source serving cell received from the target serving cell, and decoding the combined data, wherein the unsuccessfully decoded data is new transmitted data or the retransmitted data of the source serving cell, wherein
the target serving cell is a serving cell obtained after the terminal performs the serving cell change, and the source serving cell is a serving cell obtained before the terminal performs the serving cell change.

20. A network-side device, comprising a processor and a memory, wherein the memory stores a program or instructions that can be run on the processor, and when the program or the instructions are executed by the processor, steps of the information processing method according to claim 14 are implemented.
